(19) United States
(12) Patent Application Publication
(10) Pub. No.: US 2009/0075020 A1
(43) Pub. Date: Mar. 19, 2009

(54) Draining and filtering net, particularly for geotechnical applications

(75) Inventor: Cesare Beretta, Lomagna (IT)

Correspondence Address: MODIANO & ASSOCIATI, Via Meravigli, 16, MILANO, 20123, IT

(73) Assignee: TENAX S.p.A.

(21) Appl. No.: 12/232,017

(22) Filed: Sep. 10, 2008

(30) Foreign Application Priority Data
Sep. 17, 2007 (EP) 07425572

(51) Int. Cl. B32B 5/12; B32B 5/26

(52) U.S. Cl. 428/110; 442/57; 428/109; 428/220; 428/219

(57) ABSTRACT

A draining and filtering net, particularly for geotechnical applications, comprising an intermediate layer and a first outer layer and a second outer layer at the mutually opposite faces of the intermediate layer. The particularity of the invention consists in that the intermediate layer and the outer layers are provided monolithically. The intermediate layer is constituted by a plurality of substantially continuous filaments which lie along the extrusion direction. At least one layer of nonwoven fabric is further provided which is connected to one of the outer layers.

### BACKGROUND OF THE INVENTION

As is known, in the geotechnical field, draining and filtering nets are already used which are generally constituted by a mesh layer of different types, on one face of which there is a plurality of protrusions, to which a layer of nonwoven fabric is then connected.

In practice, this kind of net is designed to create a draining region for the passage of liquid and to provide filtration for the containment of particulate, sand or more or less fine debris, by means of the nonwoven fabric layer.

In practical execution, it has been observed that such nets are not always able to fully solve the problem, since they do not have the necessary mechanical strength and therefore flattenings can occur which in practice prevent correct draining.

### SUMMARY OF THE INVENTION

The aim of the invention is to solve the problem described above by providing a draining and filtering net particularly for geotechnical applications which allows to ensure, even in the most demanding applications, the containment of particulate, sand or more or less fine debris, allowing only liquid substances to pass.

Within this aim, an object of the invention is to provide a draining and filtering net which has particular mechanical strength characteristics and at the same time allows simplified manufacture.

Another object of the present invention is to provide a draining and filtering net, particularly for geotechnical applications, which thanks to its particular constructive characteristics is capable of giving the greatest assurances of reliability and safety in use.

Still another object of the present invention is to provide a draining and filtering net which can be obtained easily starting from commonly commercially available elements and materials and is also competitive from a merely economical standpoint.

This aim and these and other objects, which will become better apparent hereinafter, are achieved by a draining and filtering net, particularly for geotechnical applications, according to the invention, comprising an intermediate layer and a first outer layer and a second outer layer at the mutually opposite faces of said intermediate layer, characterized in that said intermediate layer and said first and second outer layers are provided monolithically, said intermediate layer being constituted by a plurality of substantially continuous filaments which lie along the extrusion direction, at least one layer of nonwoven fabric being further provided which is connected to at least one of said outer layers.

### BRIEF DESCRIPTION OF THE DRAWINGS

Further characteristics and advantages will become better apparent from the description of a preferred but not exclusive embodiment of a draining and filtering net, particularly for geotechnical applications, illustrated by way of non-limiting example in the accompanying drawings, wherein:

FIG. 1 is a perspective view of a draining net which, though being obtained monolithically, is shown in an exploded view to allow easier description;

FIG. 2 is a sectional view of the draining net;

FIG. 3 is a layered perspective view of the draining net;

FIG. 4 is a view of a different embodiment of the draining and filtering net;

FIG. 5 is a perspective view of a draining net with a continuous outer layer, also shown in exploded view for the sake of convenience in description;

FIG. 6 is a sectional view of the net of FIG. 5;

FIG. 7 is a layered view of the net of FIG. 5.

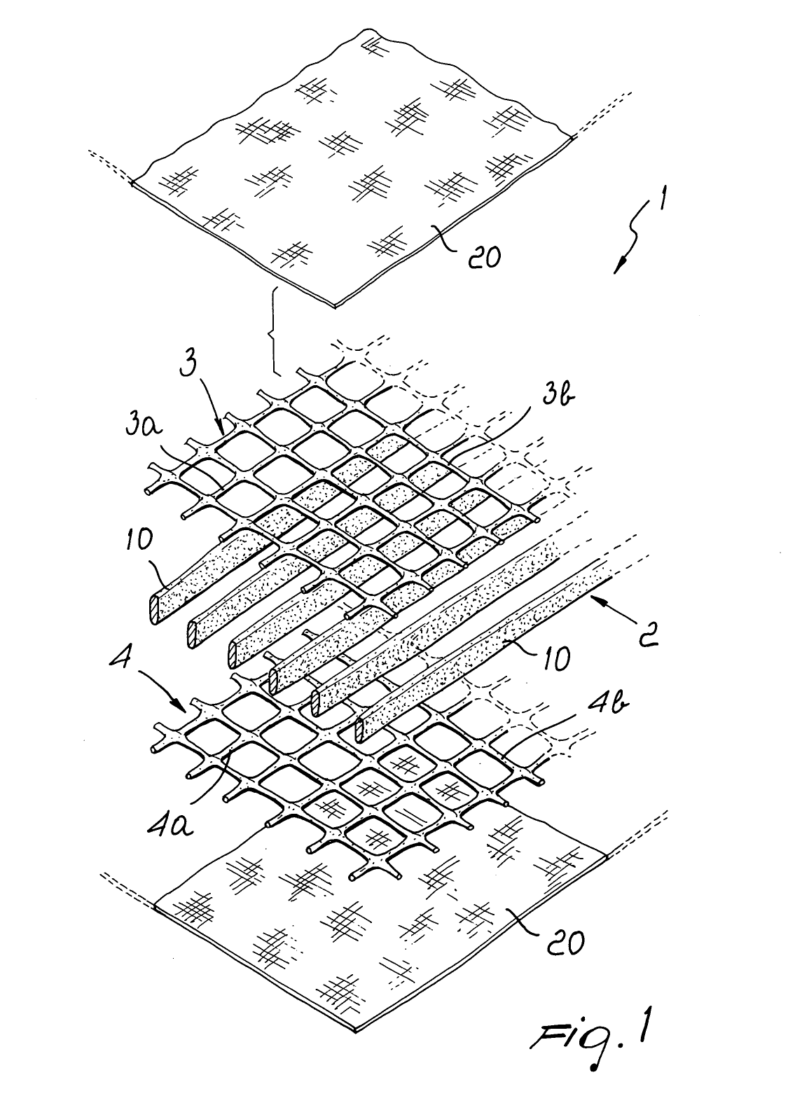

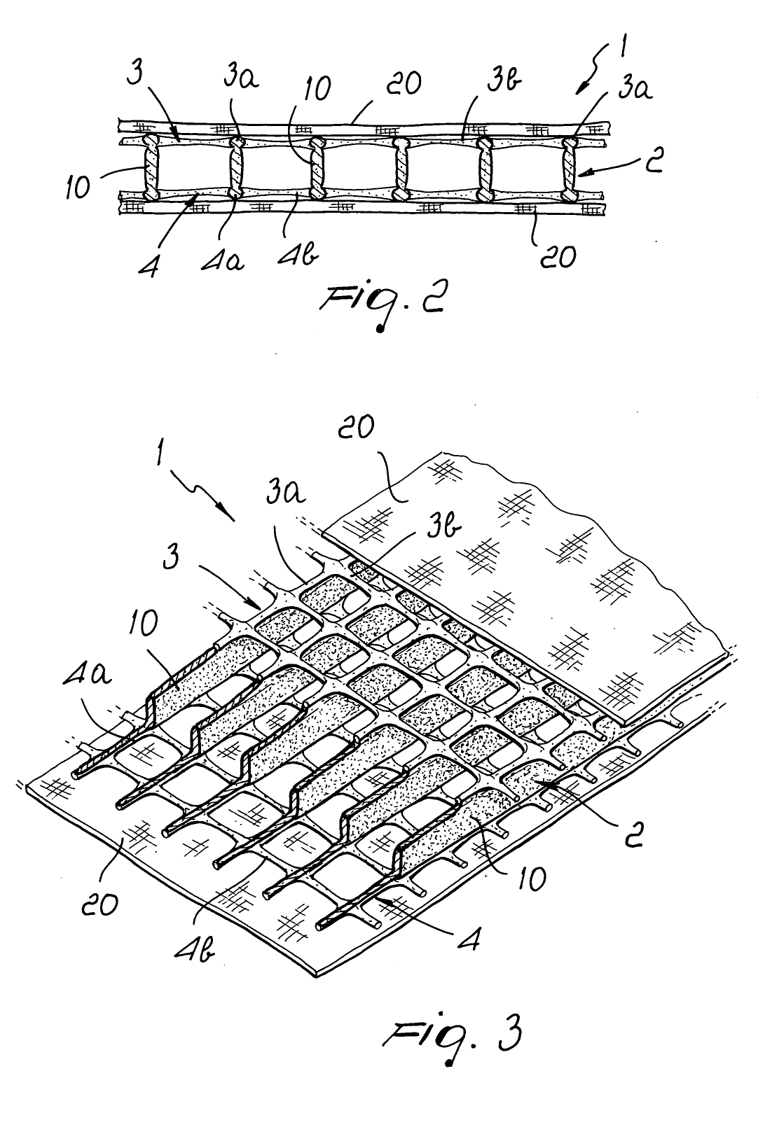

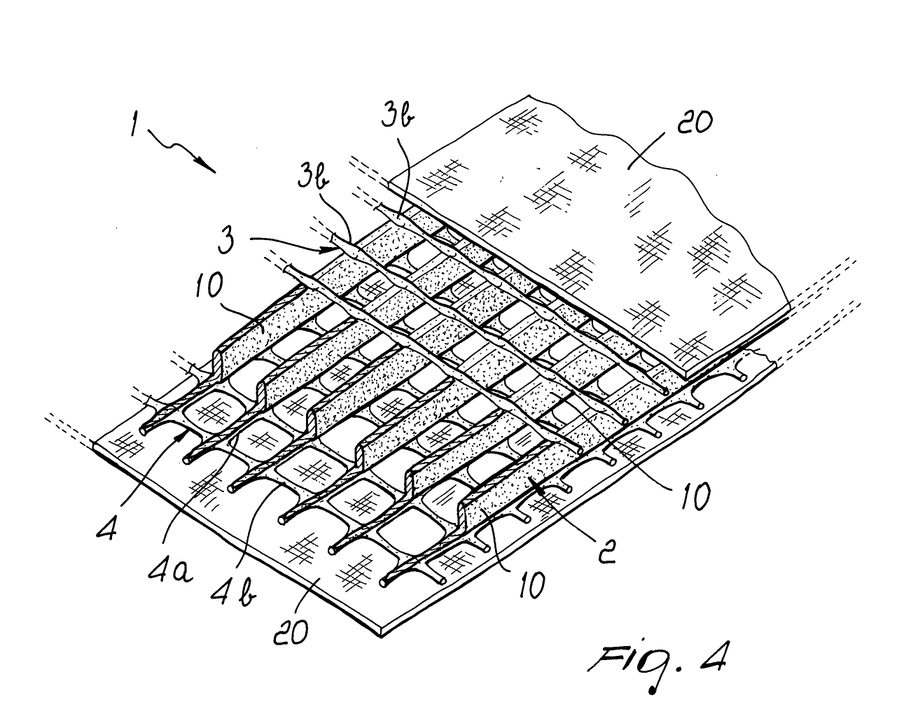

### DESCRIPTION OF THE PREFERRED EMBODIMENTS

With reference to the figures, the draining and filtering net, particularly for geotechnical applications, according to the invention, generally designated by the reference numeral 1, comprises an intermediate layer 2 and a first outer layer 3 and a second outer layer 4, which are applied at the opposite faces of the intermediate layer.

Preferably but not necessarily, the net is made of high-density polyethylene, since it has been found to be a polymer which is suitable for geotechnical applications, mixed with optional additives in order to provide the mechanical and color characteristics according to the final use and to relevant commercial requirements.

The intermediate layer 2, which is substantially the fundamental element in order to ensure good mechanical and hydraulic performance of the net, is constituted by a plurality of continuous filaments, designated by the reference numeral 10, which are arranged mutually side-by-side so as to create in practice a channel for the drained water.

The filaments 10, in a preferred but not exclusive embodiment, have a height, viewed at right angles to the plane of the net, ranging from 3 to 6 mm, and have a width, measured parallel to its plane of arrangement, ranging from 1 to 3 mm.

Tests have found that the spacing between the filaments 10 must range advantageously from 8 to 20 mm.

Outer layers 3 and 4 are provided on the opposite faces of the intermediate layer 2 and are constituted advantageously by a square-mesh net which has at least one filament 3a and 4a which is parallel to the filaments 10 and is advantageously arranged at the filaments 10.

The filaments 10 lie in the extrusion direction or main direction, while the transverse filaments of the outer layers 3 and 4, designated by the reference numerals 3b and 4b, are substantially perpendicular to the direction of arrangement of the layers 10.

An important element for completing the draining net is the presence of layers of nonwoven fabric, designated by the reference numeral 20, which are provided on the outer layers 3 and 4.

The nonwoven fabric can have different grammages, but preferably a weight of 180 g/m² is used, obtaining thicknesses and chemical properties which are suitable to obtain a good filter function and a barrier against the intrusion of debris and the like.

At this point it should be noted that the distance between the filaments 10 has been studied so as to prevent the nonwoven fabric from penetrating between the filaments 10, extending for example so as to touch the layer of nonwoven fabric of the opposite face, since accidental contact of the covering made of nonwoven fabric between the opposite outer layers would entail for example contamination of the material isolated by the geogrid with the percolation liquid, together with a considerable reduction of draining capacity.

In summary, the intermediate layer, which in practice provides the main thickness of the net according to invention, must be provided in such a way as to supply sufficient resistance to tension and compression caused by concentrated loads and/or intense surface pressures.

Moreover, it is extremely important that the draining and filtering net provided by the intermediate layer and by the outer layers is extruded in a single step and can be made of a single material or optionally with different materials as a function of the types of results to be obtained.

With reference to FIG. 4, the fact is stressed that in at least one of the outer layers, specifically the layer 3, the filament 3a, which is parallel to the filaments 10, is practically degenerated and only the transverse filaments 3b are maintained, thus optimizing the functionality of the net.

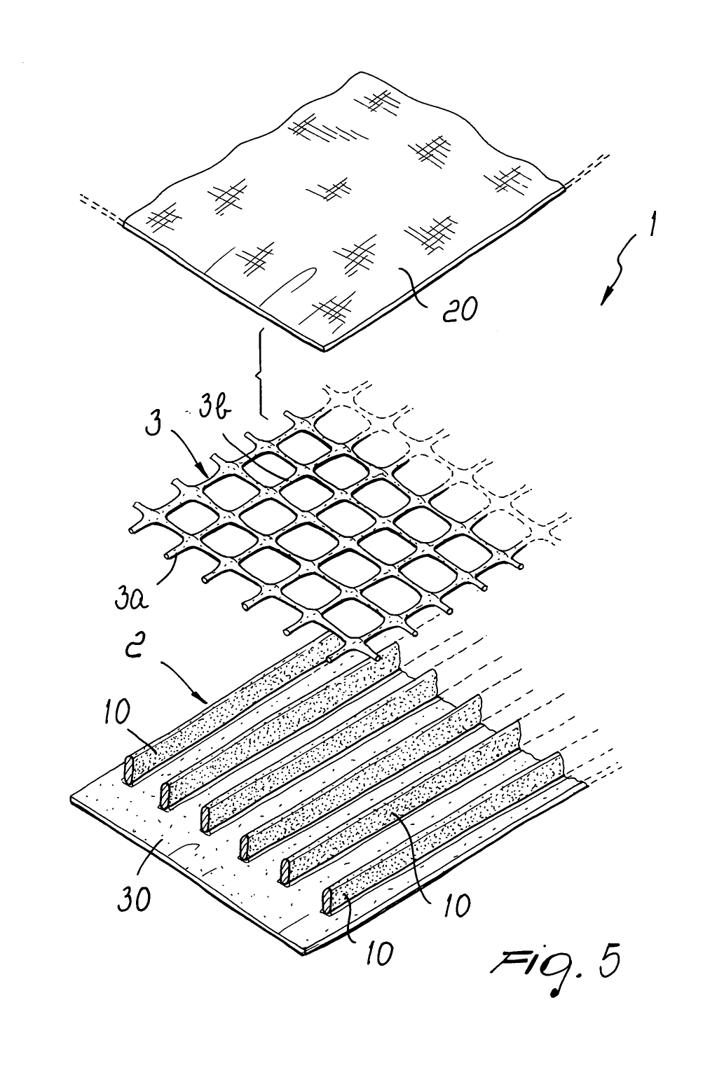

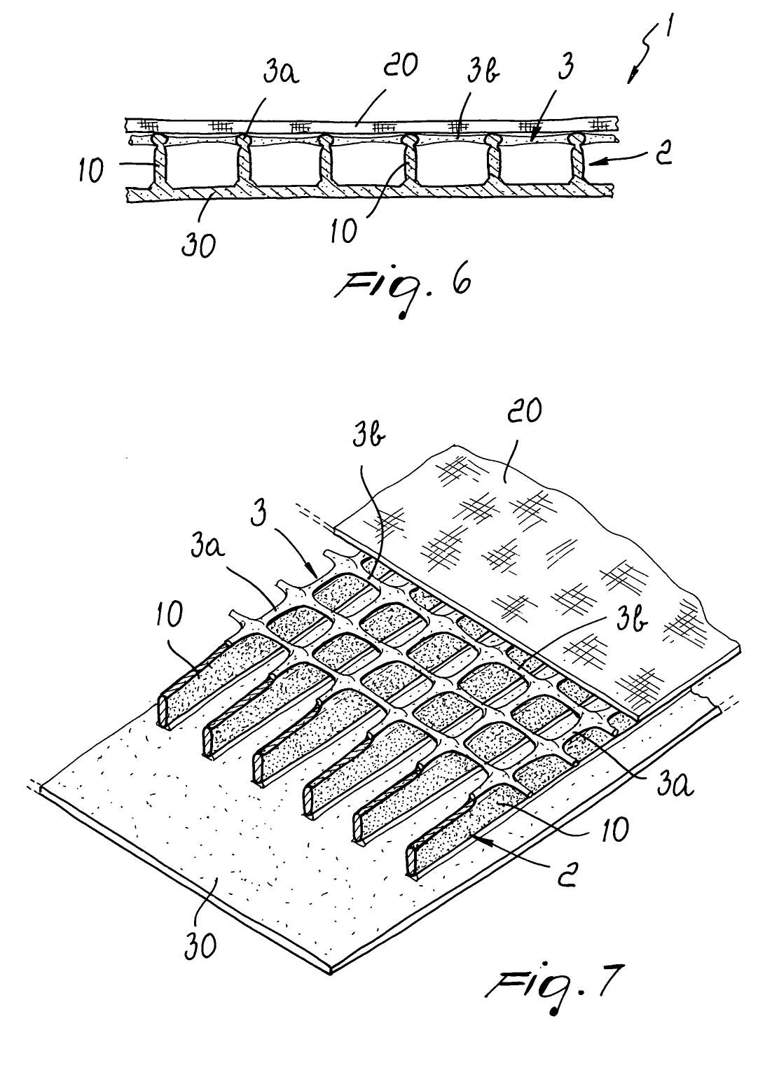

According to a further embodiment, shown in FIGS. 5 to 7, one of the layers is replaced by a continuous sheath 30, from which the filaments 10 protrude, thus obtaining a net in which it is possible to provide a separation for the draining region, while the usual layer of nonwoven fabric 20 is provided on the other layer.

In a preferred embodiment, the net has a total thickness of approximately 7 mm and has a hydraulic transmissivity, measured according to the ASTM D 4716-03 references, with a hydraulic gradient of 0.1 and an applied pressure of 1200 kPa for 100 hours, greater than 0.001 m²/s.

Traditional biplanar draining products, thickness and other operating conditions being equal, have a value of 0.0008 m²/s.

The resulting net has high-level mechanical characteristics and in particular its tensile strength per linear meter exceeds 8.5 kN/m in the extrusion direction, and it has a good flexural strength also thanks to the “core-cladding” effect obtained due to the fact that the intermediate filament oriented in the main direction, which constitutes the core, is rigidly connected to two orders of meshes on opposite faces which in practice form the cladding.

The overall thickness of the net can range from 4 to 12 mm, preferably from 5 to 9, achieving internal advantages in flexural strength, obviously with reference to loads which are adequately distributed and to pressures which are sufficiently uniform in final application.

The net preferably has a unit weight which can range from 450 to 2200 g/m².

From what has been described above, it is thus evident that the invention achieves the proposed aim and objects, and in particular the fact is stressed that a draining and filtering net, particularly for geotechnical applications, is provided in which it is possible to optimize both the draining value and the filtering values, since contact of the mutually opposite layers of nonwoven fabric is avoided absolutely.

The invention thus conceived is susceptible of numerous modifications and variations, all of which are within the scope of the inventive concept.

All the details may further be replaced with other technically equivalent elements.

In practice, the materials used, as well as the contingent shapes and dimensions, may be any according to requirements.

The disclosures in EPA 07425572 from which this application claims priority are incorporated herein by reference.

What is claimed is:

1. A draining and filtering net, particularly for geotechnical applications, comprising an intermediate layer and a first outer layer and a second outer layer at the mutually opposite faces of said intermediate layer, said intermediate layer and said first and second outer layers being provided monolithically, said intermediate layer being constituted by a plurality of substantially continuous filaments which lie along the extrusion direction, wherein said intermediate layer is thicker than each of said outer layers and at least one layer of nonwoven fabric is further provided which is connected to at least one of said outer layers.

2. The draining and filtering net according to claim 1, wherein said plurality of substantially continuous filaments has a height, substantially at right angles to the plane of arrangement of said net, which ranges from 3 to 6 mm, and a width, in a direction which is substantially parallel to the plane of arrangement of said net, which ranges from 1 to 3 mm.

3. The draining and filtering net according to claim 1, wherein the spacing between said substantially continuous filaments ranges from 8 to 20 mm.

4. The draining and filtering net according to claim 1, wherein said outer layers are constituted by a square-mesh net with at least one filament which is substantially parallel to said continuous filaments.

5. The draining and filtering net according to claim 4, wherein the transverse filaments of said outer layers lie substantially at right angles to the direction of arrangement of said continuous filaments.

6. The draining and filtering net according to claim 1, further comprising a layer of nonwoven fabric on both of said outer layers.

7. The draining and filtering net according to claim 6, wherein said layer of nonwoven fabric has a grammage of substantially 180 g/m².

8. The draining and filtering net according to claim 1, wherein said intermediate layer and said outer layers are made of a single material.

9. The draining and filtering net according to claim 1, wherein said intermediate layer and said outer layers are provided monolithically by means of mutually different materials.

10. The draining and filtering net according to claim 5, wherein at least one of said outer layers is constituted exclusively by transverse filaments which lie substantially at right angles to the arrangement of said continuous filaments.

11. The draining and filtering net according to claim 1, wherein it has a thickness ranging from 4 to 12 mm, preferably from 5 to 9 mm.

12. The draining and filtering net according to claim 1, wherein the hydraulic transmissivity is higher than 0.001 m²/s, with a hydraulic gradient of 0.1 and an applied pressure of 1200 kPa for 100 hours.

13. The draining and filtering net according to claim 1, wherein it withstands a tensile breaking strain per linear meter of 8.5 kN/m in the extrusion direction.

14. The draining and filtering net according to claim 1, wherein it has a weight ranging from 450 to 2200 g/m².

15. The draining and filtering net according to claim 1, wherein said filaments have a height between 3 and 6 mm and a width between 1 and 3 mm.
